(19) United States
(12) Patent Application Publication
(10) Pub. No.: US 2017/0370438 A1
(43) Pub. Date: Dec. 28, 2017

(54) DEVICE FOR DAMPING VIBRATIONS

(71) Applicant: SUEDDEUTSCHE GELENKSCHEIBENFABRIK GMBH & CO. KG, Waldkraiburg (DE)

(72) Inventors: Hüseyin Cabuk, Waldkraiburg (DE); Franz Kobus, Jettenbach (DE); Marc Brandl, Burgkirchen (DE); Josef Stubenrauch, Rott am Inn (DE); Steffen Jerye, Haag (DE)

(21) Appl. No.: 15/534,924

(22) PCT Filed: Dec. 9, 2015
(86) PCT No.: PCT/EP2015/079080

§ 371 Date: Jun. 9, 2017

(30) Foreign Application Priority Data
Dec. 9, 2014 (DE) 10 2014 018 212.6

(51) Int. Cl. F16F 7/116

(52) U.S. Cl. CPC F16F 7/116; F16F 2230/34; F16F 2234/06

(57) ABSTRACT

The invention relates to a device (10) for damping flexural vibrations, comprising at least one damping apparatus (DE) and at least one retaining apparatus (12) for the damping apparatus (DE), wherein the at least one damping apparatus (DE) is connected to the at least one retaining apparatus (12), and wherein the at least one damping apparatus (DE) comprises at least one damper mass (26) and at least one spring element (28, 30), wherein the at least one spring element (28, 30) is designed and preloaded in such a way that the at last one spring element (28, 30) holds the at least one damper mass (26) in a predetermined position on the at least one retaining apparatus (12) in the resting state of the device (10)

The present invention relates to a device for damping vibrations, in particular flexural vibrations and/or torsional vibrations.

One area for use of such vibration-damping devices is in the field of sliding roofs for motor vehicles, for example. The document DE 10 2008 064 548 A1 discloses a sliding roof arrangement for a motor vehicle. A frame device of the vehicle roof is designed with two longitudinal frame sections spaced a distance apart from one another, longitudinal guides for a movable vehicle part for a sliding roof cover or a roof liner part, for example, being arranged on these longitudinal frame sections. A drive cable for the vehicle component is mounted, so that it is longitudinally displaceable on each of the longitudinal frame sections. The drive cables are guided by the respective longitudinal guide to a drive device arranged between the two longitudinal guides and is movable by it. A cross member of the drive extends between the two longitudinal frame sections and carries the drive device. The cross member of the drive also carries cable guides for the drive cable between the drive device and the longitudinal frame sections. Furthermore, the cross member of the drive is mounted on the frame device so that it is mechanically coupled and/or vibration is reduced.

One object of the present invention is to provide a device for damping flexural vibrations, which can be produced easily and inexpensively and can be used in a flexible manner in various applications.

This object is achieved with a device for damping flexural vibrations of the type defined in the introduction, having the features of patent claim 1.

Additional embodiments of the invention are defined in the dependent claims.

The inventive device for damping flexural vibrations comprises at least one damping device and at least one retaining device for the damping device. The at least one damping device is connected by means of at least one spring element to the at least one retaining device. The at least one damping device comprises at least one damper mass and at least one spring element. The at least one spring element is arranged and preloaded in such a way that the at least one spring element holds the damper mass in a predetermined position on the retaining device in the resting state of the device.

The device is designed for damping flexural vibrations. To do so, the damper mass may oscillate and/or vibrate in both vertical and horizontal directions relative to the at least one retaining device, so that any flexural vibrations and oscillations that occur can be reduced reliably by the inventive apparatus.

The at least one spring element holds the at least one damper mass in a predetermined position, such that, for example, a relative movement between the at least one damper mass and the at least one retaining device is made possible. Due to the at least one spring element, for example, a predetermined distance may be set between the at least one damper mass and the at least one retaining device, this distance being necessary for a relative vibration-damping movement between the at least one damper mass and the at least one retaining device with preloading of the at least one spring element. Vibrations with a predetermined frequency and/or amplitude can therefore be reduced.

The at least one spring element may have a predetermined bias. The predetermined bias with which the at least one spring element is stretched between the at least one damper mass and the at least one retaining device may be, for example, a tensile stress caused by a tensile force. The at least one spring element can thus be stretched between the at least one retaining device and the at least one damper mass at a predetermined tensile force. However, the predetermined preload on the spring element may also be a compressive stress, which is imposed on the at least one spring element, for example, in mounting the at least one damping device on the at least one retaining device. The device can be adjusted by the preload of the at least one spring element to a predetermined frequency range of the vibrations and/or oscillations to be reduced. Furthermore, the maximum allowed amplitude of the at least one damper mass can be determined and defined relative to the at least one retaining device on the basis of the preload.

The at least one damping device may be accommodated in the at least one retaining device. The at least one retaining device may be designed in the form of a housing. The at least one retaining device is preferably designed so that the damper mass for damping the flexural vibration sin a predetermined extent can oscillate freely with compression or stretching of the at least one spring element in and/or on the at least one retaining device. The at least one retaining device may also serve as a stop for the at least one damper mass in order to limit the deflection and/or amplitude of the damper mass. In this way the at least one spring element is protected from an overload.

According to a further embodiment, the at least one retaining device may be designed of at least two components. However, the retaining device may be comprised of three or more components. The at least one two components of the at least one retaining device may be connectable for receiving the at least one damping device. This forms a closed system which can be used in a flexible manner in various fields of applications without external influences being able to affect the function of the device for damping flexural vibrations. For example, the device may be embedded in a mounting foam or the like without the foam being able to influence the function of the device and/or the mobility of the damper mass. Furthermore, the device is protected from environmental influences and the like by the retaining device. The two components of the at least one retaining device may be connected to one another by means of click connections, catch connections, screw connections or adhesive connections. The at least one spring element may be vulcanized separately from the at least one retaining device. A modular design is achieved in this way, wherein the at least one spring element and the at least one damper mass are connected to one another and are then coupled to the at least one retaining device. The at least one damper mass may also be vulcanized together with the at least one spring element.

According to another embodiment, the at least one retaining device has at least one retaining site, which is used for coupling to the at least one spring element. The at least one retaining site of the at least one retaining device may be designed, for example, so that the at least one spring element is secured on the retaining site for coupling to the at least one retaining device. In the case of a retaining device embodied as two or more parts, the at least one retaining site may be formed between two or more components of the at least one retaining device. In this context, the at least one spring element may also be designed with at least one fastening element. The at least one fastening element may be accommodated in the at least one retaining site of the at least one retaining device. Starting from its fastening element and/or the retaining site, the at least one spring element extends in the direction of the at least one damper mass and is connected to it. Accordingly, the at least one spring element may be in contact with the at least one retaining device only in the area of its at least one fastening element and may then extend freely in the direction of the at least one damper mass. In this way, the vibration capability of the at least one damper mass is ensured on the at least one retaining device and/or in the at least one retaining device.

According to one embodiment, the at least one fastening element of the at least one spring element may be designed to be complementary to the at least one retaining site on the at least one retaining device. The shape of the at least one fastening element may thus be adapted to the shape of the at least one retaining site. If the at least one retaining device is comprised of two components, then the at least one retaining site is formed by the two components of the retaining device. In its cross section, the retaining site formed by the two components of the retaining device may then be designed to be complementary to the shape of the at least one fastening element. The at least one fastening element may be designed with a triangular round or oval cross section. However, other types of cross-sectional shapes are also conceivable as long as a coupling is achieved between the at least one spring element and the at least one retaining device.

The at least one damper mass may be designed in multiple parts. If the at least one damper mass is designed in two parts, then the at least one spring element may be accommodated in at least some sections between the two parts of the at least one damper mass and connected to the damper mass in this way. In this case, the at least one spring element may be designed with a fastening element, which is to designed for accommodation between the two parts of the damper mass. The parts of the at least one damper mass may be provided with recesses, which may form a receptacle for the at least one fastening element of the at least one spring element. The at least one fastening element of the at least one spring element and the receptacle in the damper mass may be designed to be complementary.

Accordingly, the at least one spring element may be designed with a fastening element adapted to the retaining site of the retaining device and one additional fastening element adapted to the receptacle of the at least one damper mass.

The damper mass may be designed to be cylindrical or rod shaped. The damper mass as well as the entire device may be adapted in their shape to their site of use and/or their area of use and may have a corresponding shape, depending on the area of use.

According to one embodiment, the at least one spring element may have at least one reinforcement. The at least one reinforcement may be a textile reinforcement and/or thread reinforcement in particular. The spring element can absorb higher tensile forces in particular due to the reinforcement. The at least one spring element may preferably be made of rubber or an elastomer. The tensile load on the at least one spring element may be relieved by the at least one reinforcement, which thus contributes to the lifetime of the spring element. The at least one reinforcement may be provided at the surface of the at least one spring element. The at least one reinforcement may also extend through a central region of the spring element. The at least one reinforcement may be provided on individual surfaces or all surfaces of the at least one spring element. The at least one reinforcement may preferably be provided on opposing surfaces of the at least one spring element.

According to one embodiment, the at least one retaining device may have ribs. The ribs may serve to secure the damper mass in the event of failure of the at least one spring element. The ribs may extend in the retaining device in such a way that the cross section of the retaining device is reduced in a certain area. The ribs may extend in an interior and/or receiving section for the damper mass formed by the retaining device and thereby reduce its cross section. In the event of failure and breakage, for example, of the at least one spring element during use, then the damper mass can be secured by the ribs in the retaining device. Therefore, the noise generated by an uncontrollable damper mass in this state can be prevented.

The at least one damping device may be connected to the at least one retaining device in a pivotably movable manner. For example, a type of hinge may be provided, connecting the at least one damper mass of the at least one damping device pivotably to the at least one retaining device. The at least one spring element in this case serves to reduce the pivoting movements of the at least one damper mass. The at least one damping device may also be connected to the at least one retaining device by means of the at least one spring element in addition to the pivotably movable connection.

The at least one retaining device may also have a fluid for damping the movements of the at least one damper mass. The at least one retaining device may thus be filled with a damping fluid, which can reduce the movements of the at least one damper mass required for the vibration damping effect. The damping of the moving damper mass can be influenced in a targeted manner by the damping fluid. For example, the vibration damper and/or the damper mass together with the apring element assigned to it can be adapted to predetermined excitation amplitudes or excitation frequencies by means of a damping fluid.

The at least one retaining device may have at least one throttle element. The at least one throttle element can throttle a fluid flow occurring due to movement of the at least one damper mass. In one simple embodiment, the at least one retaining device may have throttle gaps predetermined for this purpose, reducing the rate of the fluid flow occurring due to the movement of the at least one damper mass. Therefore, the movement of the damper mass is in turn reduced to a predetermined extent and thus the damping behavior of the damper mass is influenced in a targeted manner.

The at least one retaining device may be designed in the form of a ring. The at least one retaining device may be designed with a rectangular cross section. The at least one annular retaining device may have at least one inside circumferential wall according to one embodiment and at least one outside circumferential wall. The at least one retaining device may be designed in two or more parts. A first component may be designed, for example, with a U-shaped cross section. The first component may thus have two longitudinal legs in cross section and a transverse leg connecting the longitudinal legs. In this case, the second component may be a closure element. The closure element may be designed to be disk-shaped, for example.

The at least one damping device may be connected to the at least one inside circumferential wall. The at least one damping device may extend around an exterior radial surface of the at least one inside circumferential wall, for example. The at least one damping device may also be in contact with the radial outer surface of the at least one inside circumferential wall in at least some sections.

According to one embodiment, the at least one spring element of the at least one damping device may extend between the at least one inside circumferential wall and the at least one damper mass. The at least one spring element may also establish a connection between the at least one inside circumferential wall and the at least one damper mass.

According to one embodiment, the at least one spring element may be fixedly connected to the at least one damper mass before being mounted on the at least one retaining device. Following the connection of at least one spring element to the at least one damper mass, the damping device formed by the spring element and the damper mass may be connected to the retaining device. Due to the connection of the damping device to the at least one retaining device and/or to its at least one inside circumferential wall, the at least one spring element may be acted upon with a predetermined bias.

According to one embodiment of the invention, the at least one retaining device may be designed in such a way that a predetermined gap is established between the at least one damper mass and the at least one retaining device. The predetermined gap may be formed, for example, between a side surface of the at least one damper mass and a surface of the at least one retaining device which is opposite this side surface of the at least one damper mass. The at least one retaining device may be designed so that the predetermined gap has a predetermined shape in the cross section of the retaining device. In particular, the shape of the predetermined gap is based on the interaction with the at least one damper mass. The damping of the device can be adjusted, based on the predetermined gap. A variable damping, in particular a progressive damping of the device can be adjusted by means of the predetermined gap. The predetermined gap may be designed so that the at least one damper mass in the at least one retaining device can be decelerated by fluid cushions, for example, air cushions. The at least one damper mass may be in contact with a surface of the at least one retaining device at its side surfaces. The receiving section may therefore be subdivided into two chambers. The air cushions in the chambers may serve to decelerate the damper mass and limit the amplitude of the vibrations. The at least one damper mass may be in contact with the at least one retaining device on its side surface opposite the gap. The at least one damper mass may be in contact with at least one surface of the retaining device and guided there. Therefore, a guided sliding movement between the at least one damper mass and the retaining device can be achieved. The at least one damper mass may be guided by means of at least one guide web on the at least one retaining device.

The at least one retaining device may be designed so that the predetermined gap changes with the deflection of the at least one damper mass relative to the at least one retaining device. In other words, the predetermined air gap, which is established between the at least one retaining device and the at least one damper mass, can change, i.e., increase or decrease, as a function of the deflection of the at least one damper mass. For example, the dimension of the predetermined gap may change, i.e., increase or decrease, in a transverse direction relative to the direction of vibration of the at least one damper mass.

The predetermined gap may be the largest in at least one location in the resting state of the device. The at least one retaining device may be designed so that the predetermined gap decreases with an increase in the vibration amplitude of the at least one damper mass. The dimension of the predetermined gap can be reduced with an increase in the amplitude of the damper mass. The damper mass can be decelerated in this way by the fluid cushions, for example, air cushions, formed in the at least one retaining device. A progressive damping of the damper mass can therefore be supplied, and striking of the damper mass against the at least one retaining device can be effectively prevented. In other words, if the damper mass is in contact at one of its side surfaces with the at least one retaining device, and if the gap decreases in the direction of vibration of the damper mass, then with an increase in the vibration amplitude, less air can flow out of one chamber into the other chamber in the at least one retaining device. The damper mass may thus be decelerated by the air cushion in the chamber, so that a variable damping and in particular a progressive damping can be achieved.

The at least one spring element may extend between at least two retaining sites.

The at least one spring element may extend through an opening in the at least one damper mass. The at least one spring element may also be connected to the at least one damper mass. The at least one spring element may be connected by at least one spring web to the at least one damper mass. The at least one spring web may be situated in the at least one opening in the resting state of the device.

The at least one spring element may have a section, which forms at least one stop buffer. The at least one stop buffer may reduce the impact of the at least one damper mass on the at least one retaining device if adequate damping cannot be achieved by means of the fluid cushion in one of the chambers. The at least one stop buffer may be facing at least one of the retaining sites of the at least one spring element. The at least one stop buffer may be provided on an end area of the at least one opening in the at least one damper mass. If the at least one spring element is connected by at least one bushing to the at least one damper mass then the at least one stop buffer may be provided on at least one of the end faces of the at least one bushing.

Exemplary embodiments of the invention are described below with reference to the accompanying figures, in which:

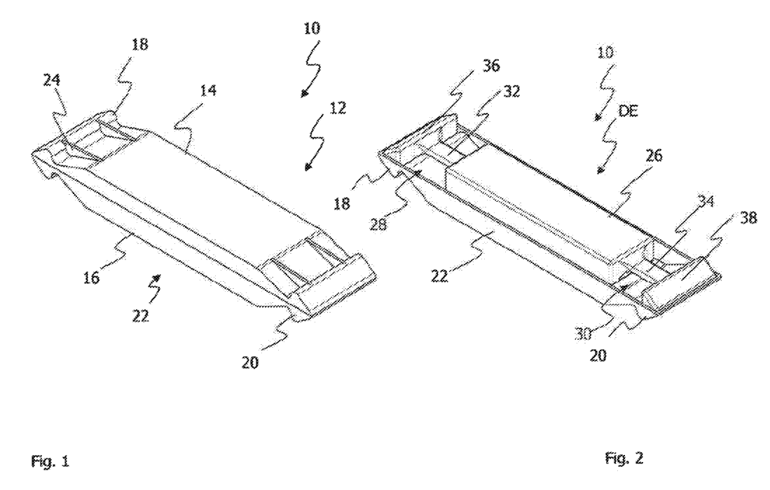

FIGS. 1 and 2 show perspective views of the device according to a first embodiment of the invention;

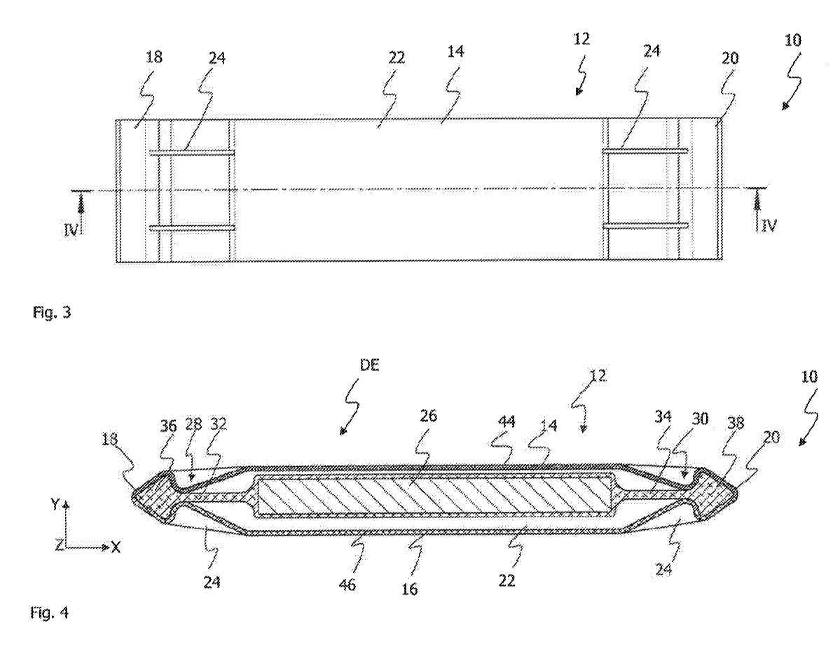

FIG. 3 shows a top view of the device according to the first embodiment of the invention;

FIG. 4 shows a side view along the sectional line III-III in FIG. 3;

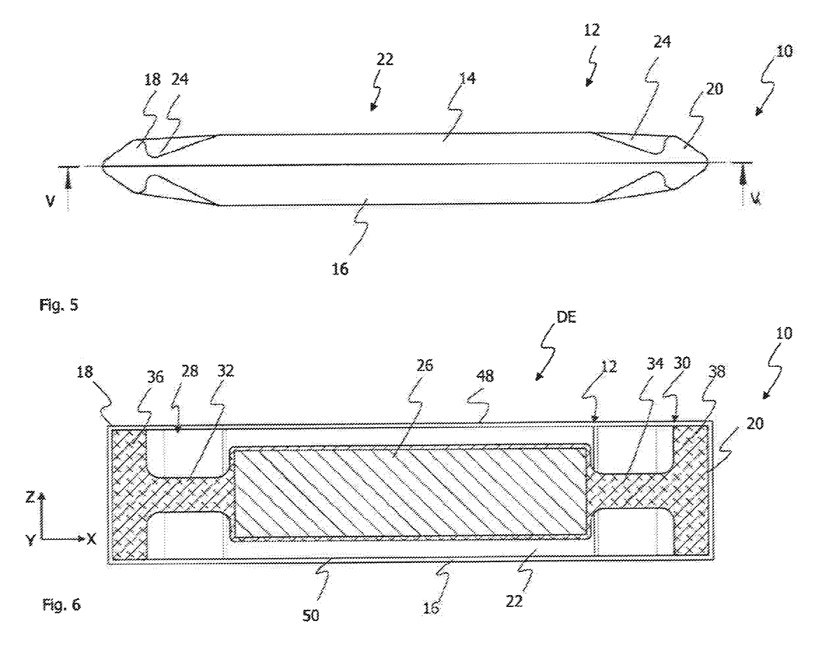

FIG. 5 shows a side view of the device according to the first embodiment of the invention;

FIG. 6 shows a sectional view along the sectional line V-V in FIG. 5;

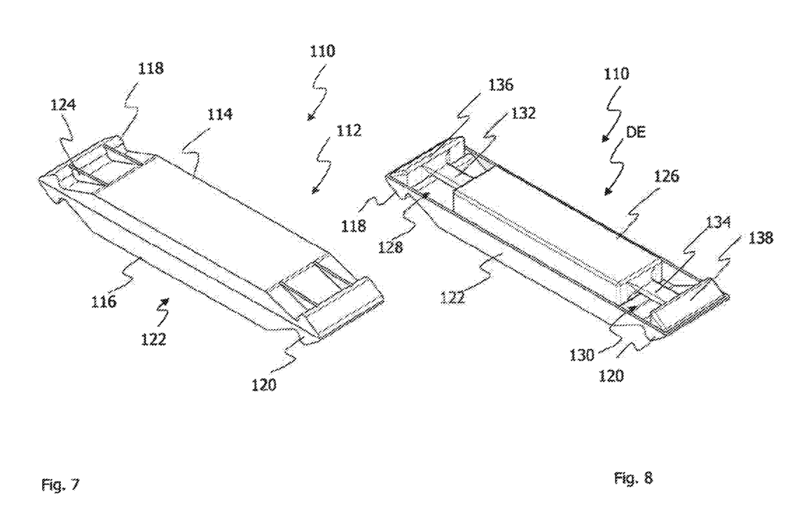

FIGS. 7 and 8 show perspective views of the device according to a second embodiment of the invention;

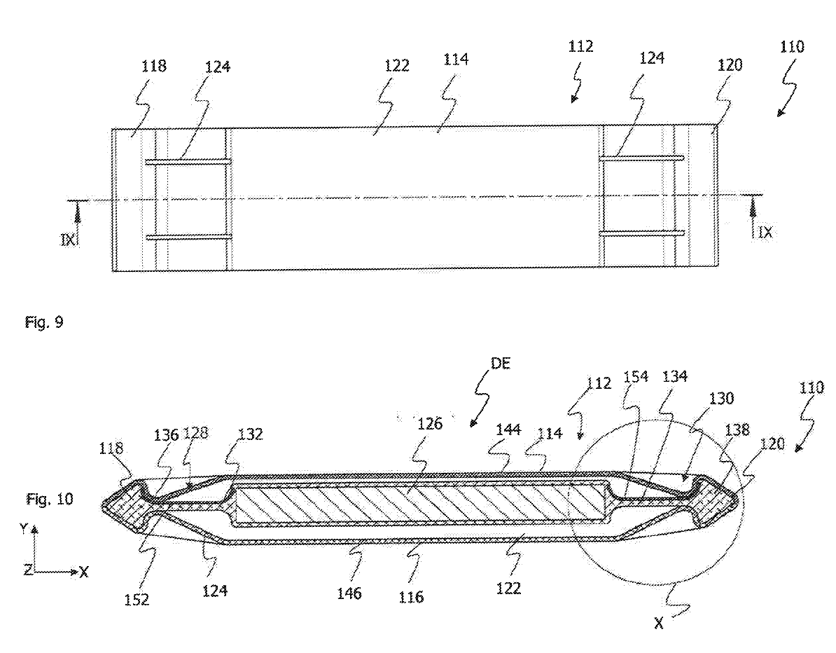

FIG. 9 shows a top view of the device according to the second embodiment of the invention;

FIG. 10 shows a sectional view along the sectional line IX-IX in FIG. 9;

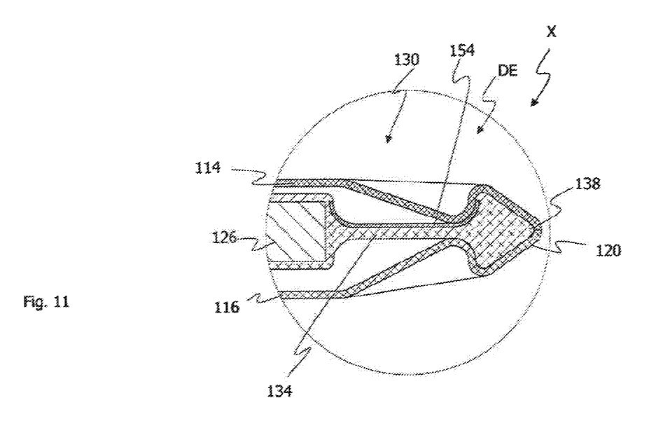

FIG. 11 shows a detail view of the detail X in FIG. 10;

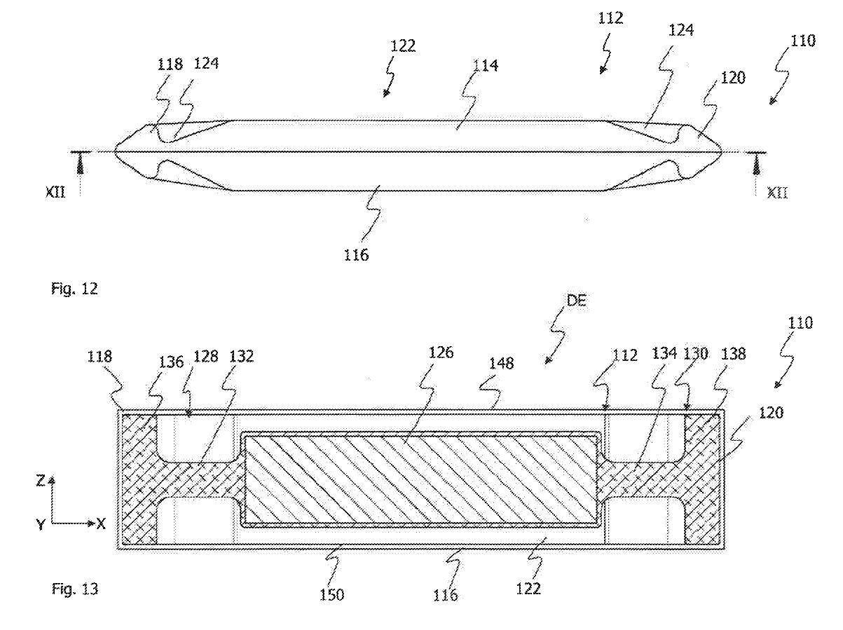

FIG. 12 shows a side view of the device according to the second embodiment of the invention;

FIG. 13 shows a sectional view along the sectional line XII-XII in FIG. 12;

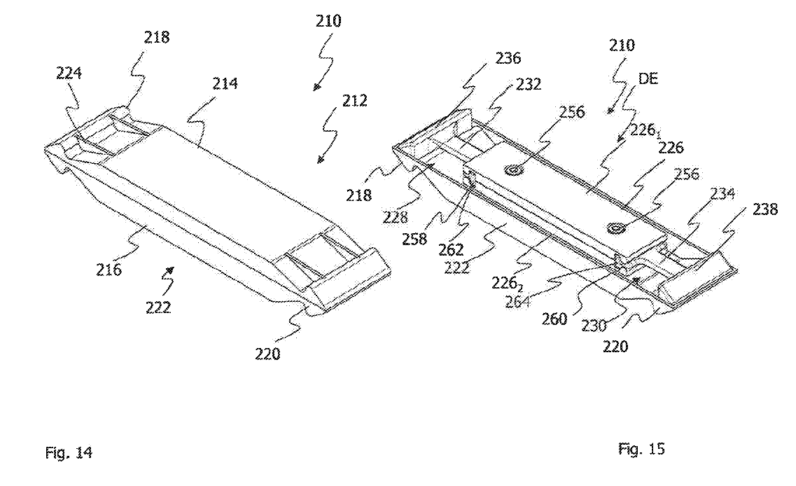

FIGS. 14 and 15 show perspective views of the device according to a third embodiment of the invention;

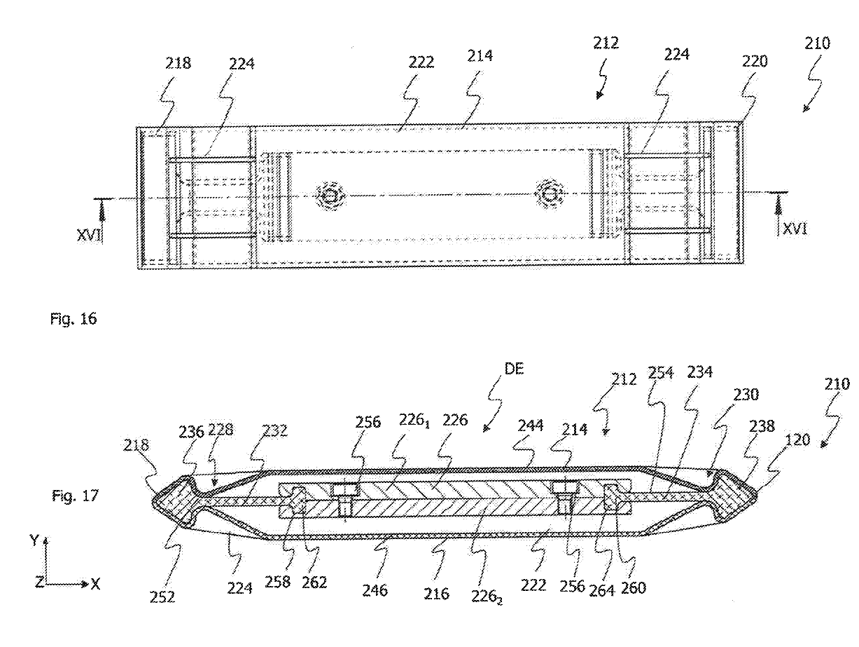

FIG. 16 shows a top view of the device according to the third embodiment of the invention;

FIG. 17 shows a sectional view along the sectional line XVI-XVI in FIG. 16;

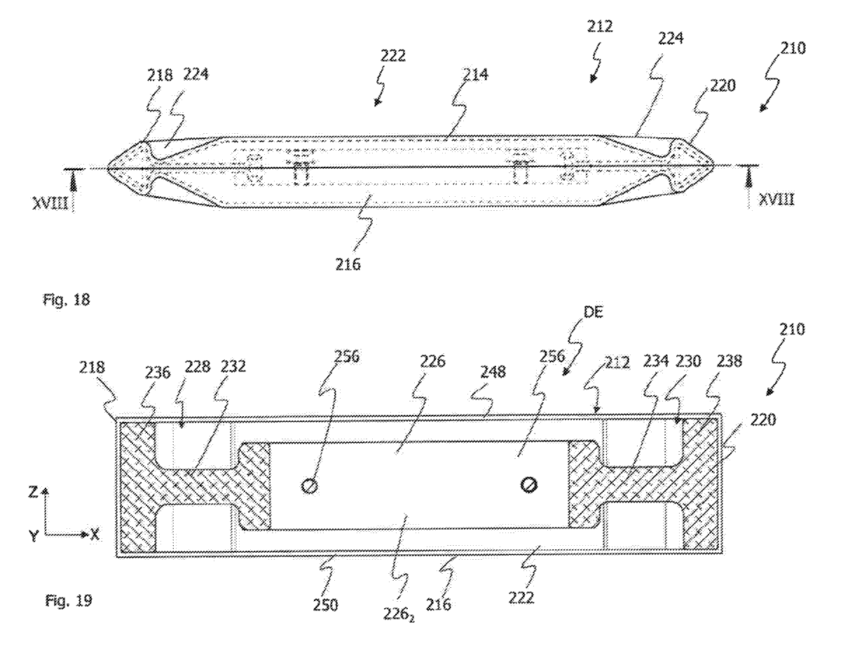

FIG. 18 shows a side view of the device according to the third embodiment of the invention;

FIG. 19 shows a sectional view along the sectional line XVIII-XVIII in FIG. 18;

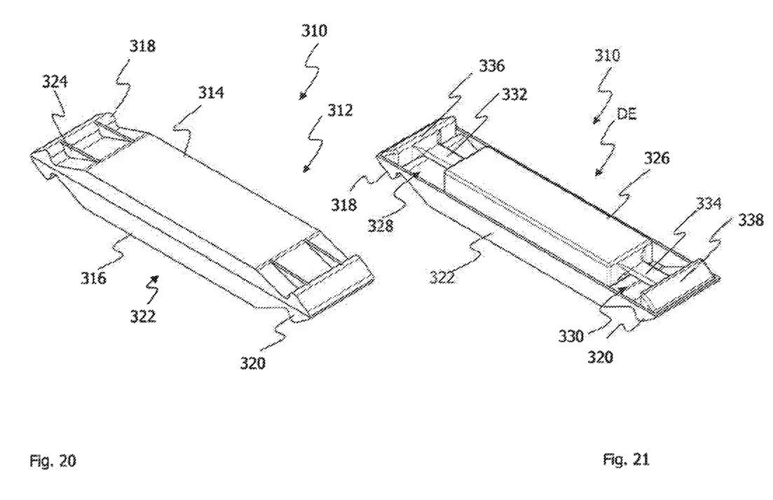

FIGS. 20 and 21 show perspective views of the device according to a fourth embodiment of the invention;

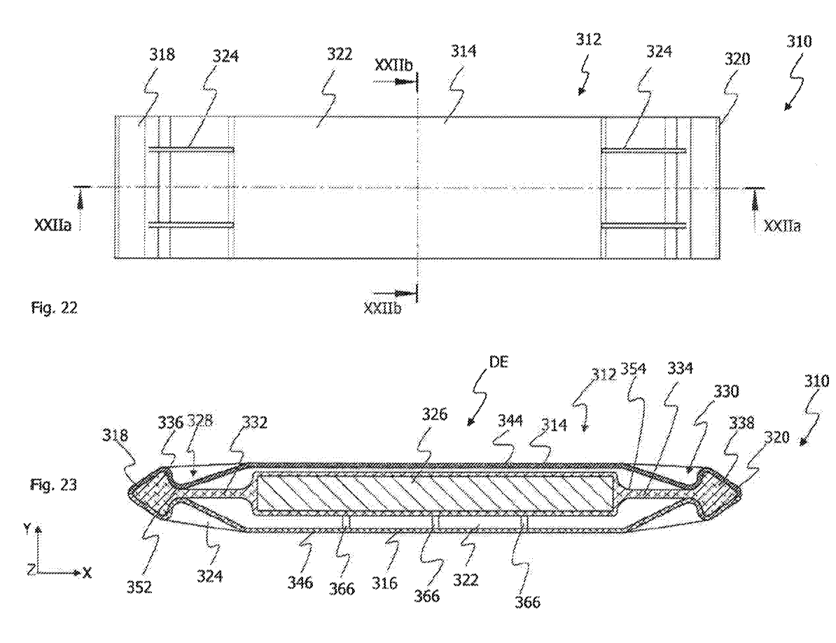

FIG. 22 shows a top view of the device according to the fourth embodiment of the invention;

FIG. 23 shows a sectional view along the sectional line XXIIa-XXIIa in FIG. 22;

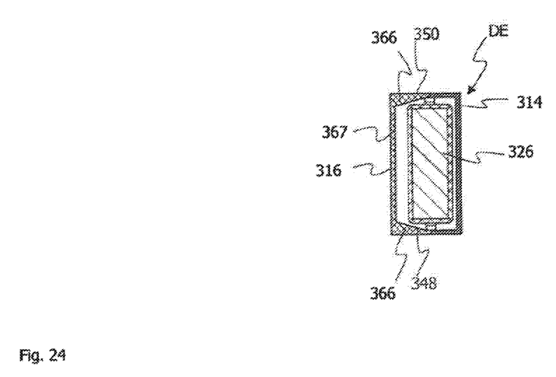

FIG. 24 shows a sectional view along the sectional line XXIVb-XXIVb in FIG. 22;

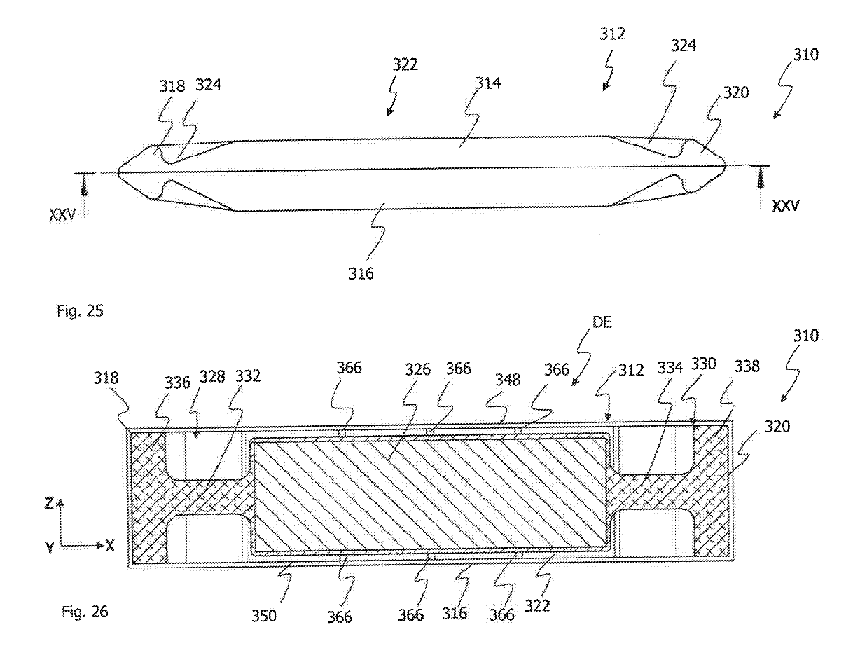

FIG. 25 shows a side view of the device according to the fourth embodiment of the invention;

FIG. 26 shows a sectional view along the sectional line XXV-XXV in FIG. 25;

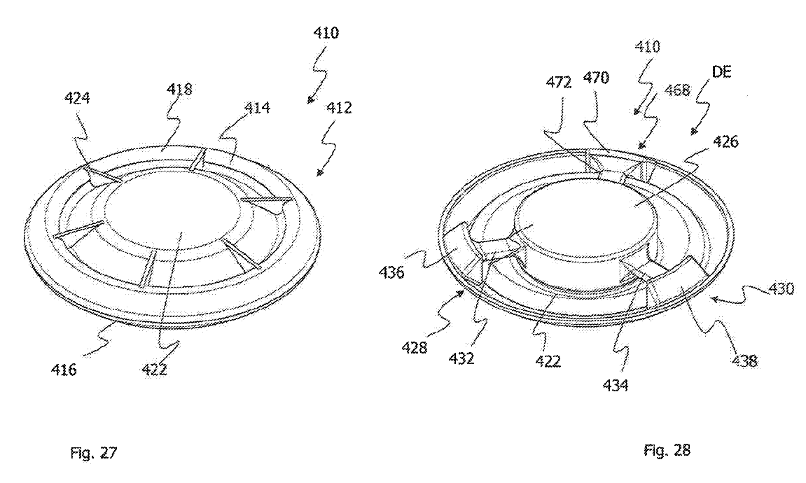

FIGS. 27 and 28 show perspective views of the device according to a fifth embodiment of the invention;

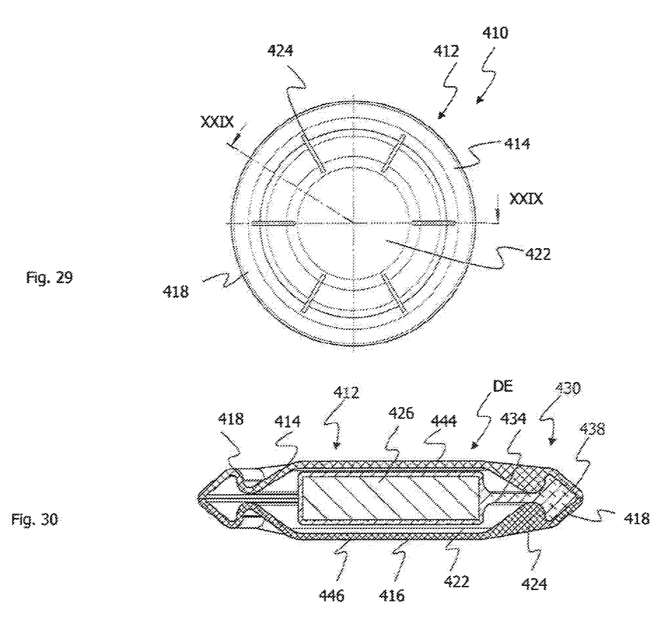

FIG. 29 shows a top view of the device according to the fifth embodiment of the invention;

FIG. 30 shows a sectional view along the sectional line XXIX-XXIX in FIG. 29;

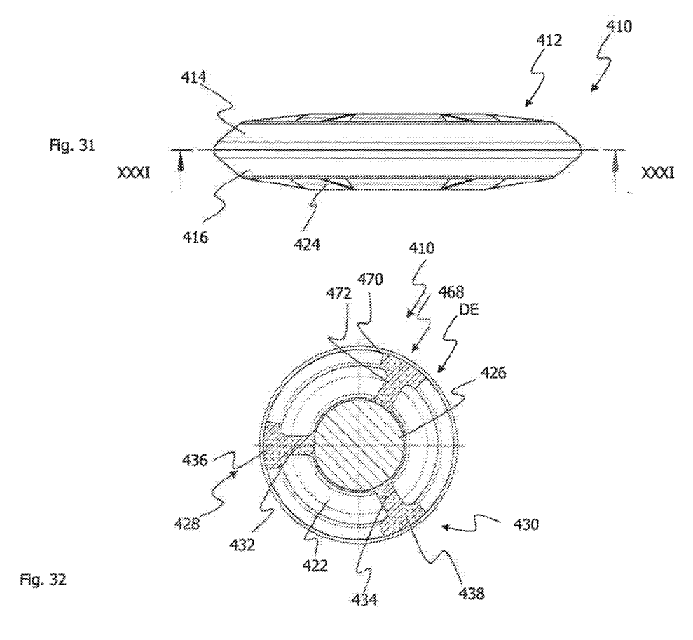

FIG. 31 shows a side view of the device according to a fifth embodiment of the invention;

FIG. 32 shows a sectional view along the sectional line XXXI-XXXI in FIG. 31;

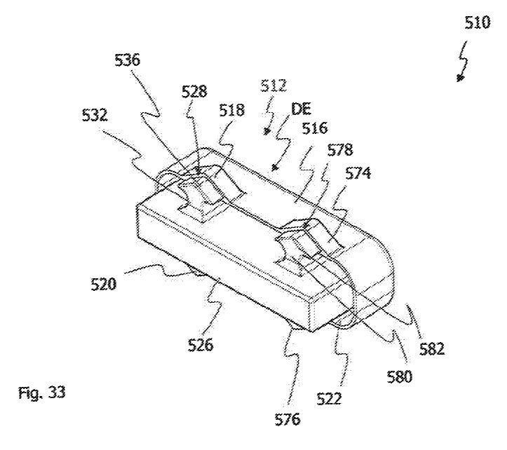

FIG. 33 show a perspective view of the device according to a sixth embodiment of the invention;

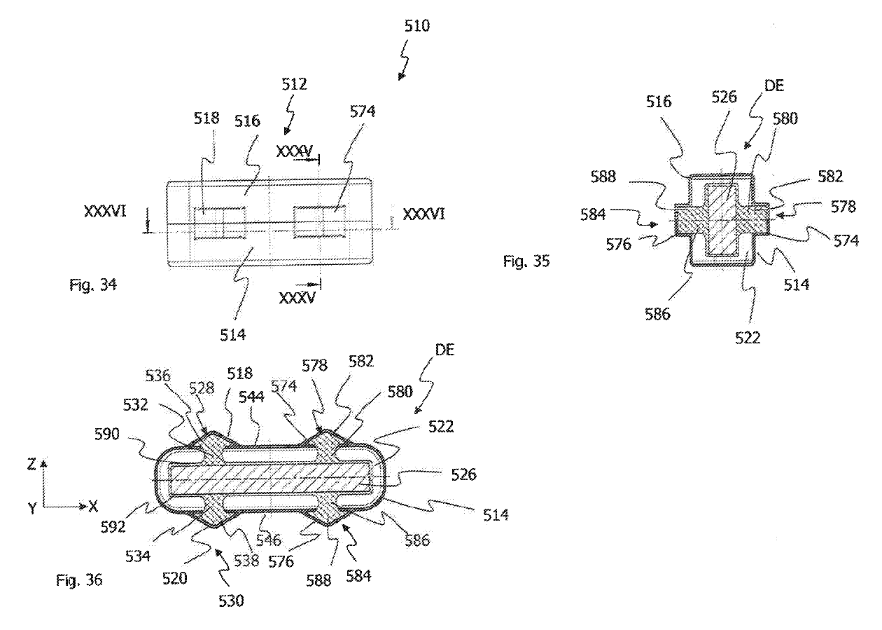

FIGS. 34 to 36 show additional views of the device according to the sixth embodiment of the invention;

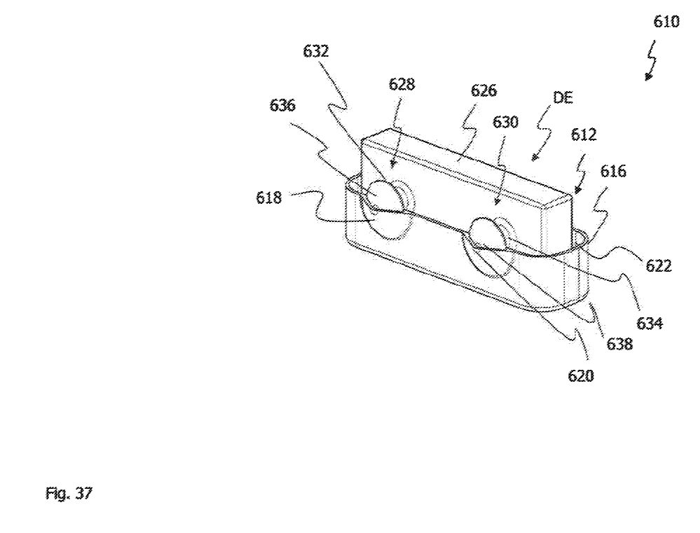

FIG. 37 show a perspective view of the device according to a seventh embodiment of the invention;

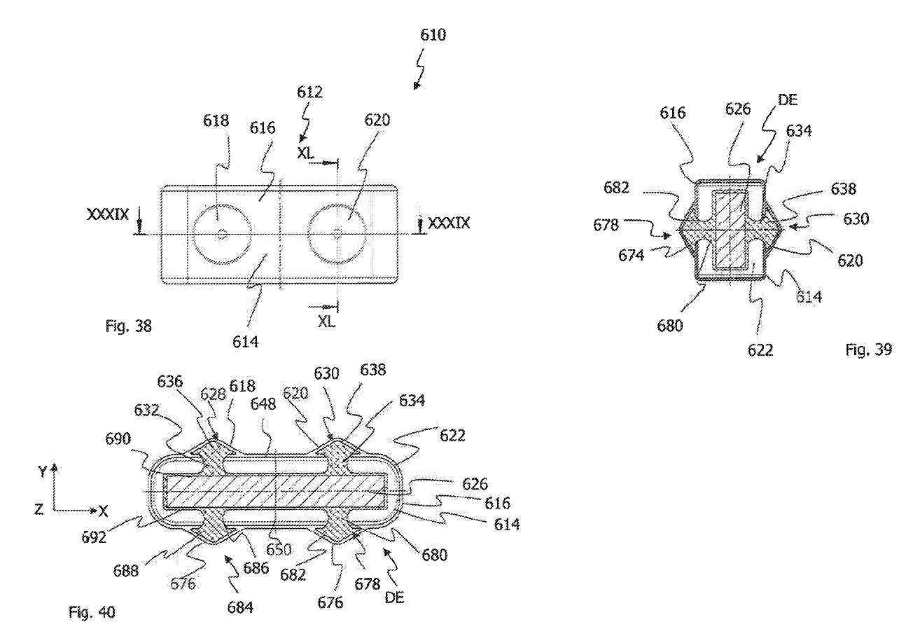

FIGS. 38 to 40 show additional views of the device according to the seventh embodiment of the invention;

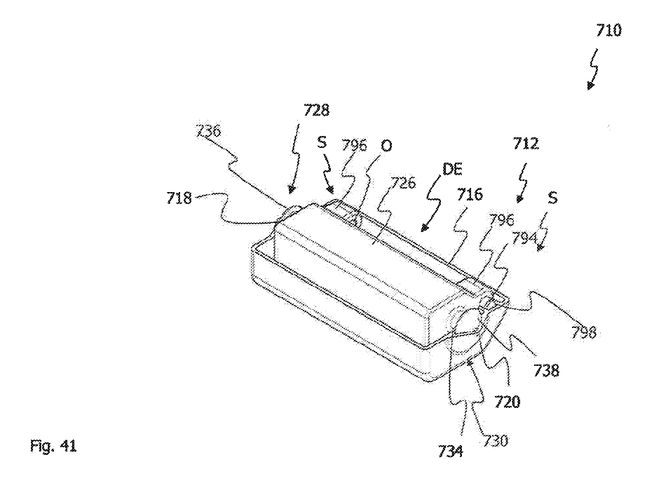

FIG. 41 show a perspective view of the device according to an eighth embodiment of the invention;

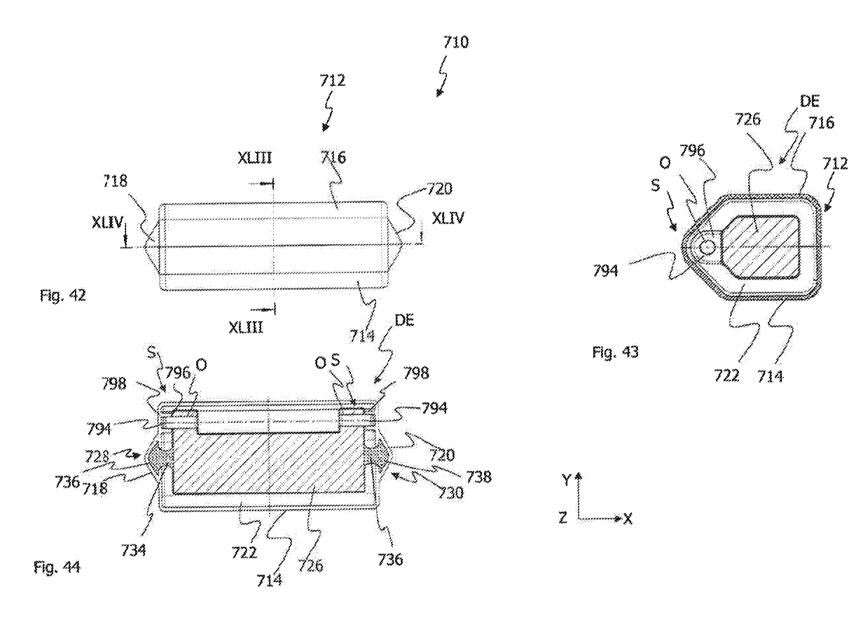

FIGS. 42 to 44 show additional views of the device according to the eighth embodiment of the invention;

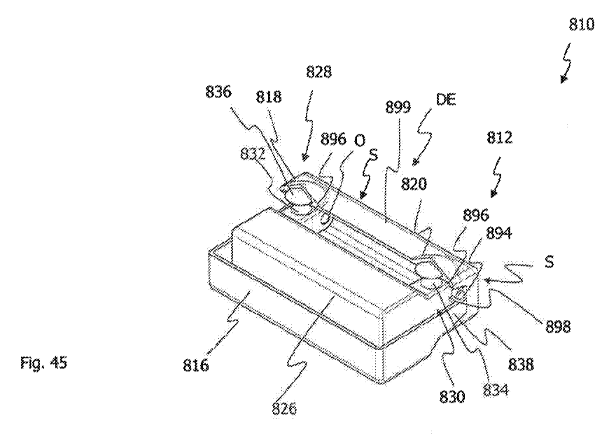

FIG. 45 show a perspective view of the device according to a ninth embodiment of the invention;

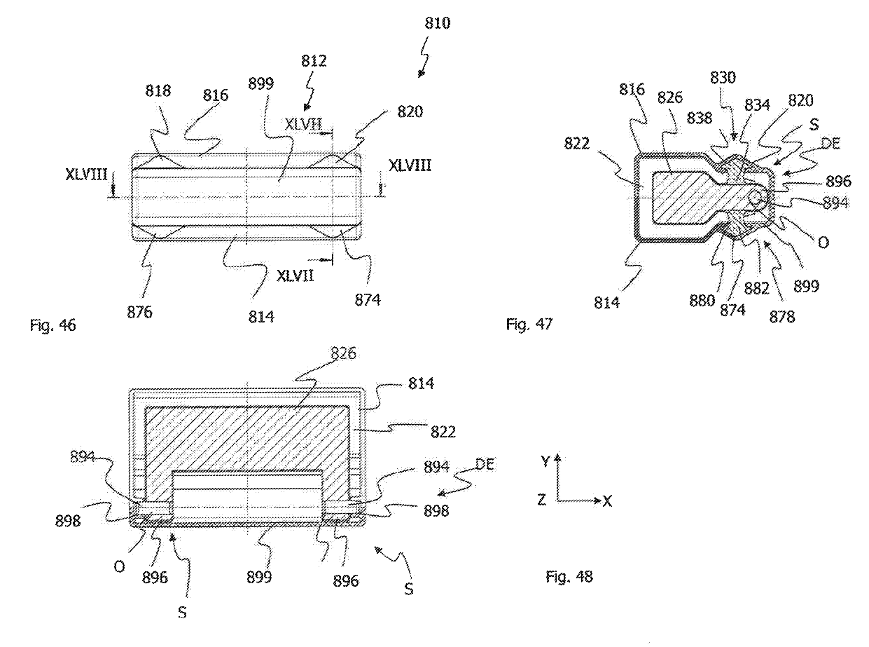

FIGS. 46 to 48 show additional views of the device according to the ninth embodiment of the invention;

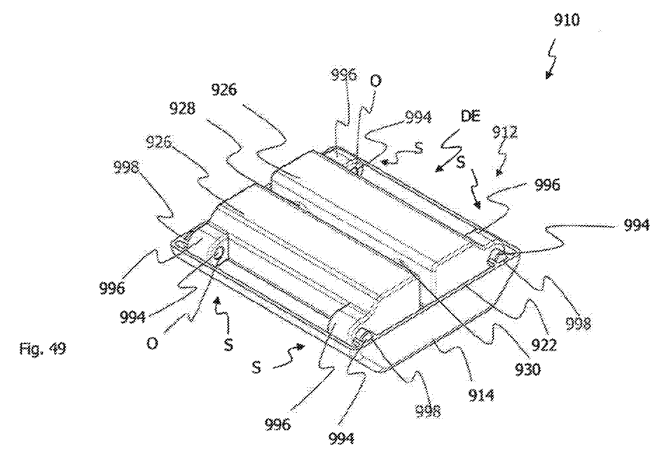

FIG. 49 show a perspective view of the device according to a tenth embodiment of the invention;

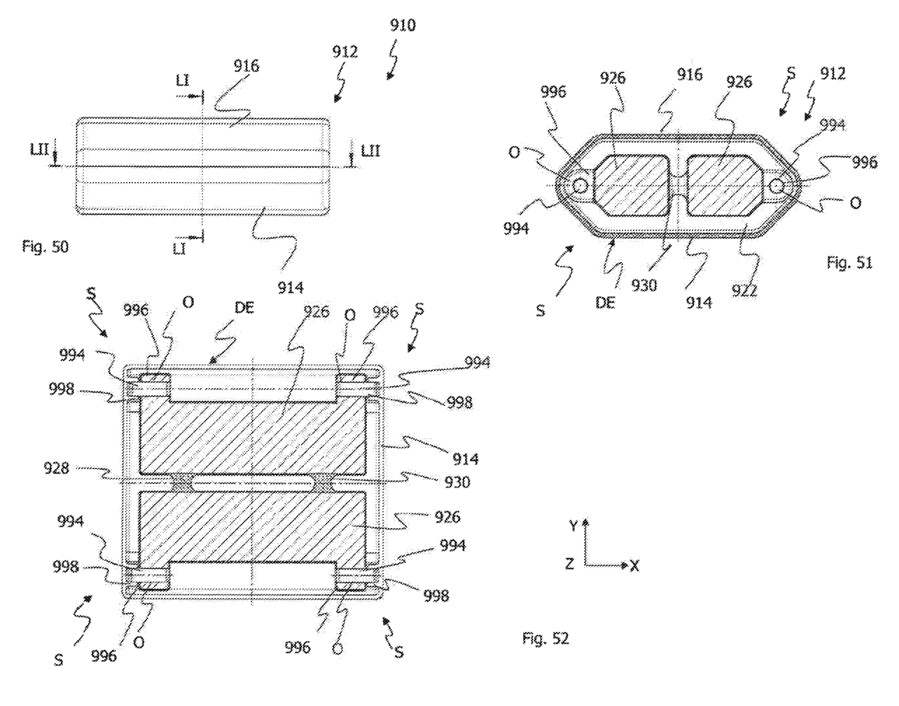

FIGS. 50 to 52 show additional views of the device according to the tenth embodiment of the invention;

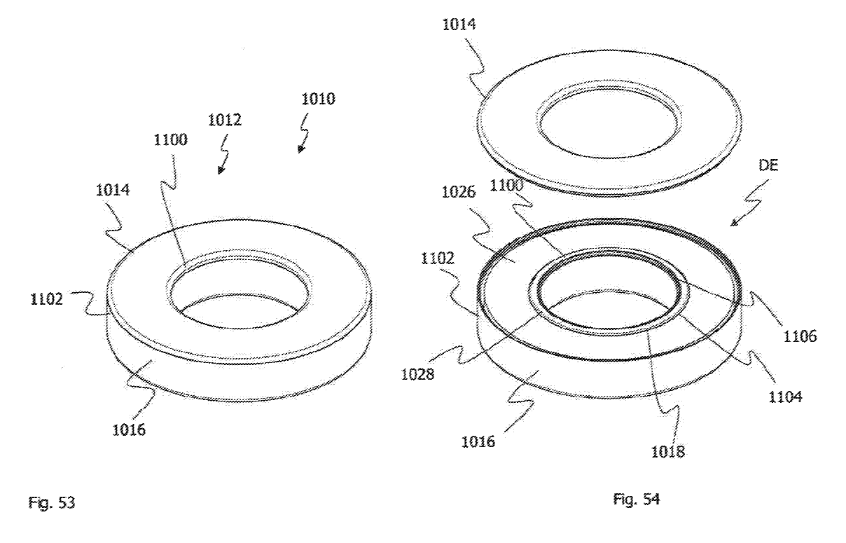

FIGS. 53 and 54 show perspective views of the device according to an eleventh embodiment of the invention;

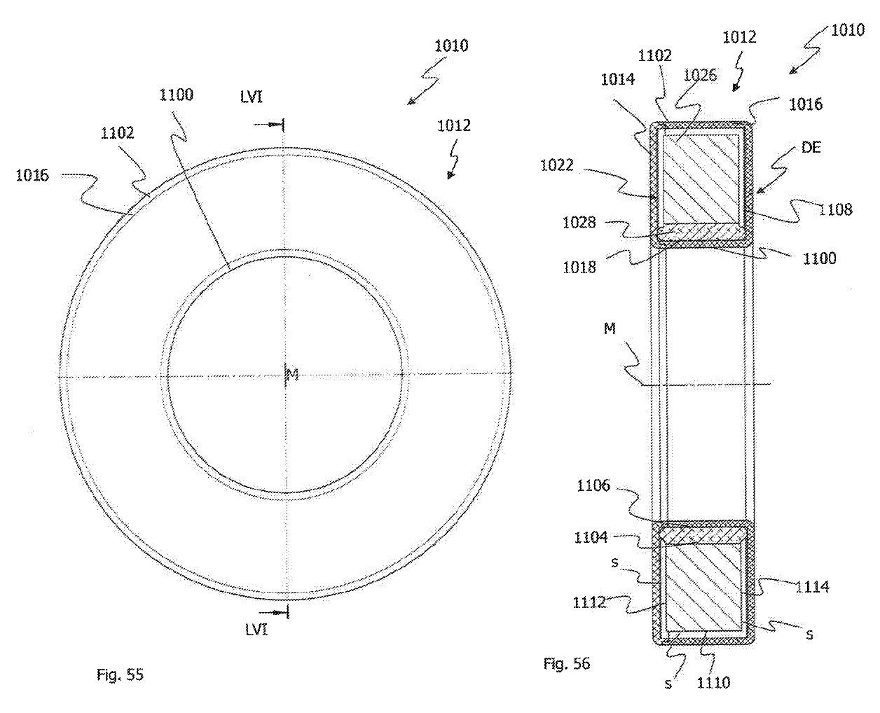

FIGS. 55 and 56 show additional views of the device according to the eleventh embodiment of the invention;

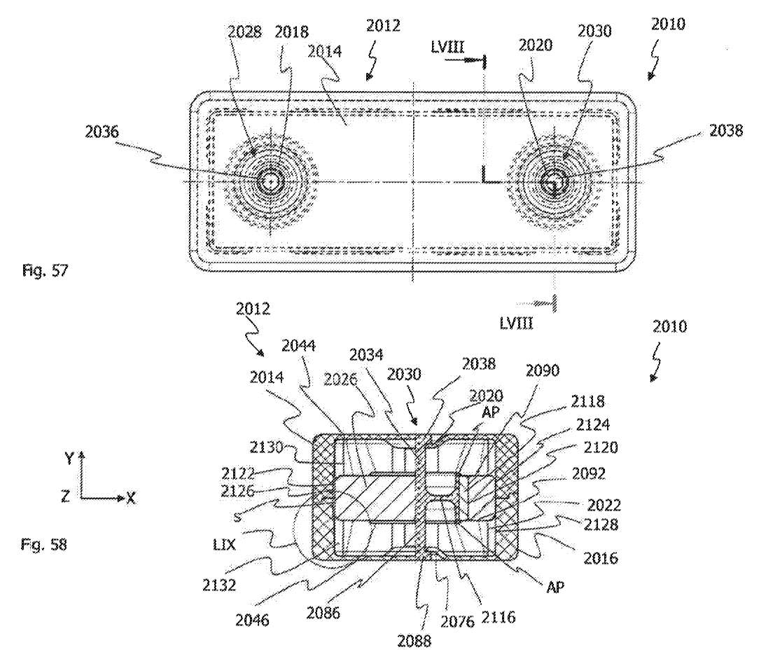

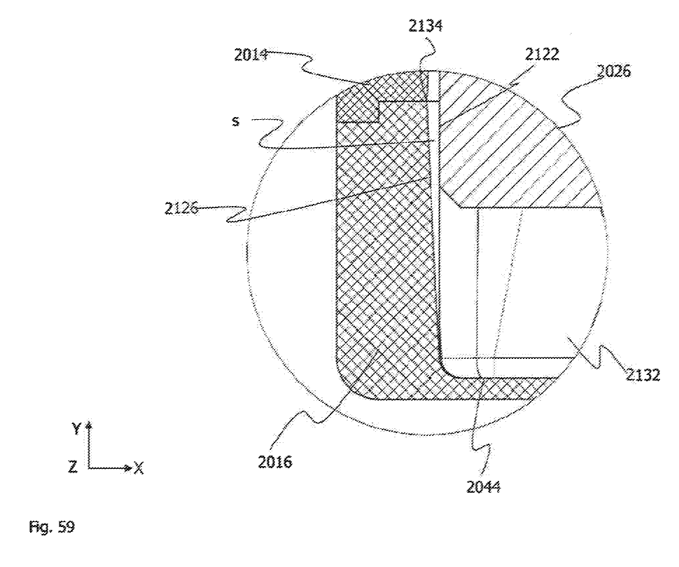

FIGS. 57 to 59 show views of the device according to a twelfth embodiment of the invention; and

FIGS. 60 to 62 show views of the device according to a thirteenth embodiment of the invention.

FIG. 1 shows a perspective view of the device for damping flexural vibrations labeled with 10 in general.

The device 10 comprises a retaining device 12 which is designed in the form of a housing. The retaining device, i.e., the housing 12 is comprised of two components 14 and 16. The retaining device 12, i.e., the housing has two retaining sites 18 and 20 which serve to connect with a spring element (FIG. 2) which is not shown in FIG. 1. The two halves, i.e., parts 14 and 16 of the housing 12 may be connected to one another by means of a snap connection, a screw connection or an adhesive connection. The device 10 is elongated and is desired to accommodate a damping device (not shown in FIG. 1). Between the retaining sites 18 to 20 and the receiving section 22 for the damping device (FIG. 2) reinforcing ribs 24 can be seen, serving to reinforce the housing components, i.e., the housing halves 14 and 16.

FIG. 2 shows a perspective view of the device 10 without the housing halves 14.

The damping device DE of the device 10 comprises a damper mass 26 and spring 2o elements 28 and 30. The damper mass 26 is accommodated in the receiving section 22 of the housing component 16. The damper mass 26 is connected to the housing component 16 and/or to the retaining sites 18 and 20 of the housing component 16 by means of the spring elements 28 and 30. The spring elements each have a spring section 32 and 34 which develops into a fastening section 36, 38 and also serves to connect to the damper mass 26. The fastening sections 36, 38 and/or the fastening elements 36, 38 are accommodated in the retaining sites 18, 20 and serve to couple the spring elements 28, 30 to the retaining sites 18, 20 of the housing halves 16.

The fastening elements 36 and 38 are designed to be complementary to the retaining sites 18 and 20.

FIG. 3 shows a top view of the device 10 in which the housing halves 14 can be seen. The housing halves 14 and/or the housing 12 is/are provided with retaining sites 18, 20. The reinforcing ribs 24 for reinforcing the housing 12 extend between the receiving section 22 and the retaining sites 18 and 20.

FIG. 4 shows a sectional view along the sectional line IV-IV in FIG. 4.

In the assembled state, the housing halves 14 and 16 form the receiving section 22 for the damper mass 26 between them. The damper mass 26 is coupled to the housing 12 by means of the spring elements 28 and 30. To do so, the spring elements 28 and 30 have fastening elements 36 and 38 which are accommodated in the retaining sites 18 and 20 in the housing 12. The retaining sites 18 and 20 and the fastening elements 36 and 38 are designed to be complementary to one another.

The fastening elements 36, 38 are designed to be essentially triangular in cross section and can be accommodated in the suitably designed retaining sites 18 and 20. The fastening elements 36 and 38 can be secured between the housing parts 14 and 16. The retaining sites 18 and 20 in the assembled state of the housing 12 form a receptacle for the fastening elements 36 and 38, the receptacle being designed with a triangular cross section in the assembled state of the housing 12. Starting from the fastening elements 36 and 38, the spring elements 28, 30 extend with their elongated spring sections 32 and 34 in the direction of the damper mass 26. The spring elements 28 and 30 are produced from an elastomer, in which the damper mass 26 can be embedded in at least some sections or completely.

The damper mass 26 can oscillate in the receiving section 22 for damping vibrations and oscillations in the vertical and horizontal directions, i.e., in the X and Y directions. The housing and/or the housing parts 14 and 16 become(s) narrower in the direction of the retaining sites 18 and 20. Accordingly, the damper mass 26 can oscillate in the X direction until the damper mass 26 comes to a stop on the tapering sections 40 and 42 against one or, alternately, both of the walls of the housing 12. In the Y direction, the damper mass 26 can oscillate until it comes to a stop on one of the walls 44 and 46 of the housing parts 14 and 16, which run parallel to the longitudinal axis of the housing 12. Thus a maximum allowed amplitude of the damper mass 26 is secured by means of the housing 12. In this way, overloading of the spring elements 28, 30 can be prevented. Depending on the field of use, the housing 12 may be made of aluminum, plastic or steel.

By assembling the housing parts 14 and 16, the fastening elements 36, 38 of the spring elements 28, 30 are secured in the retaining sites 18 and 20 and are coupled to the housing 12 in this way.

FIG. 5 shows a side view of the device 10.

The housing 12 of the device 10 is comprised of the housing parts 14 and 16, which, in the assembled state, form a receiving area 22 and retaining sites 18 and 20 for the spring elements. The spring elements 28 and 30 as well as the damper mass 26 are accommodated completely in the housing 12.

FIG. 6 shows a sectional view along the sectional line V-V in FIG. 5.

The damper mass 26 is embedded in the elastomer used to produce the spring elements 28 and 30. The fastening elements 36, 38 couple the spring elements 28 and 30 to the housing 12 and/or to the housing part 16 in FIG. 6. The elongated spring section 32, 34 of the spring elements 28, 30 extends between the fastening elements 36 and 38 and the damper mass 26. The damper mass may also oscillate in Z direction to a limited extent until its deflection is limited by one of the side walls 48, 50 of the housing part 16. The fastening elements 36, 38 extend in the Z direction over the entire cross section of the housing part 16 and reduce their cross section in the direction of the spring section 32, 34.

Additional embodiments of the invention are described below. The same reference numerals are used for similar features or those having the same effect but with an additional number added in front.

FIG. 7 shows a perspective view of the device 110.

The device 110 corresponds in its design largely to the device 10 described with reference to FIGS. 1 to 6 according to the first embodiment of the invention.

To avoid repetition, in this context reference is made only to the differences between the embodiments described in detail with reference to FIGS. 1 to 6 and the embodiment according to FIG. 7 through 13.

FIG. 8 shows a perspective view of the device 110 without the housing part 114.

FIG. 9 shows a top view of the device 110.

FIG. 10 shows a sectional view along the sectional line IX-IX in FIG. 9.

FIG. 10 shows the housing 112 with its housing halves 114 and 116. The housing halves 114 and 116 form the retaining sites 118 and 120 for the fastening elements 136 and 138 of the spring elements 128 and 130 between them. The elongated spring sections 132 and 134 connect the fastening elements 136, 138 to the damper mass 126. The spring elements 128 and 130 are in turn made of an elastomer in which the elongated or rod-shaped damper mass 126 is also embedded. Furthermore, a reinforcement 152 and 154 is embedded in the elastomer. The reinforcement 152 and 154 extends in sections in the area of the fastening elements 136, 138 and the spring sections 132 and 134 and forms a surface of the spring elements 128 and 130. The reinforcement 152 and 154 serves to absorb tensile forces acting on the spring elements 128 and 130 during operation of the device 110. The reinforcement 152, 154 should accordingly relieve the load on the spring elements 128 and 130 during tensile loading, which contributes to the lifetime of the spring elements 128 and 130. If the damper mass 126 oscillates relative to the housing 112, the spring elements 128, 130 are loaded by tension and pressure in alternation. Under tensile loads on the spring elements 128 or 130, the load of the elastomer of the spring elements 128 and 130 can be reduced by the reinforcement 152 and/or 154.

FIG. 11 shows a detail view of the detail X in FIG. 10.

FIG. 11 shows the reinforcement 154 which extends in sections to the outside surfaces of the spring section 134 and of the fastening element 138. The reinforcement 154 runs further in the direction of the damper mass 126 until the elastomer develops into the section running parallel to the housing wall 144 on the damper mass 126. Accordingly, the reinforcement 154 runs in the shape of a trough along the elastomer of the spring element 130 in the area of the fastening element 138 and the spring section 134. The reinforcement may be in particular a thread reinforcement and/or textile reinforcement.

FIG. 12 shows a side view of the device 110.

FIG. 13 shows a sectional view of the device 110 along the sectional line XII-XII in FIG. 12.

FIG. 14 shows a perspective view of the device 210 according to a third embodiment of the invention.

The housing 212 of the device 210 is designed to be identical to the housings of the two embodiments described above.

FIG. 15 shows the device 210 in a perspective view without the housing part 214.

The damper mass 226 according to this embodiment is designed in two parts. The parts 226₁ and 226₂ are connected to one another by means of screws 256. The parts 226₁ and 226₂ of the damper mass 226 form receptacles 258 and 260 between them for the spring elements 228 and 230. For accommodation in the receptacles 258, 260, the spring elements 228, 230 are provided with fastening elements 262 and 264 which are designed to be complementary to the cross section of the receptacles 258, 260. The receptacles 258 and 260 are designed with a cross section in the form of a 90° rotated T. The fastening elements 262 and 264 are designed accordingly in the form of a 90° rotated T and are secured in the receptacles 258, 260 by means of the screws 256.

FIG. 16 shows a top view of the device 210.

FIG. 17 shows a sectional view along the sectional line XVI-XVI in FIG. 16.

FIG. 16 shows the screws 256, which are used for connecting the damper mass parts 2261 and 2262 to one another.

Between them, the damper mass parts 226₁ and 226₂ form receptacles 258, 260 for the fastening elements 262 and 264 of the spring elements 228 and 230.

According this embodiment, the damper mass 226 is not enclosed completely in an elastomer.

The fastening elements 262 and 264 are designed in the form of a 90° rotated T and are accommodated in the receptacles 258 and 260. However, the fastening elements 262 and 264 may also have other shapes, as long as they are accommodated in their shape in the receptacles 258 and 260 in the damper mass 226 and can ensure a secure connection to the damper mass 226. The spring elements 228, 230 can be produced separately and/or vulcanized separately and then connected to the damper mass 226. The damper mass 226 may be inserted together with the spring elements 228 and 230 into one of the housing halves 214, 216. The fastening elements 236, 238 are secured in the holding sites 218, 220 of the housing 212 and are thus coupled to the housing 212.

FIG. 18 shows a side view of the device 210.

FIG. 19 shows a sectional view along the sectional line XVIII-XVIII in FIG. 18.

FIG. 19 shows that the damper mass 226 is not embedded completely in the elastomer used to produce the spring elements 228, 230. Instead the spring elements 228, 230 and/or their fastening elements 262, 264 are accommodated in the receptacles 258, 260 in the damper mass 226.

FIGS. 20 and 21 show perspective views of a device 310 according to a fourth embodiment of the invention.

The fourth embodiment according to FIGS. 20 to 26 corresponds mostly to the embodiment described with reference to FIGS. 1 to 6.

FIG. 22 shows a top view of the device 310.

FIG. 23 shows a sectional view along the sectional line XXIIa-XXIIa in FIG. 22.

FIG. 23 shows the housing 312, the damper mass 326 and the spring elements 328 and 330. The spring elements 328 and 330 couple the damper mass 326 to the housing 312 by means of their fastening elements 336 and 338.

Ribs 366 which serve to secure the damper mass in the event of failure of the one or both spring elements 328 and 330 can be seen in the housing half 316. For example, if one of the spring elements 328, 330 happens to fail, the damper mass can be secured in the housing 312 by means of the ribs 366. This method of securing the damper mass 326 in the housing 316 prevents the damper mass from being able to move freely, i.e., uncontrollably, in the housing 312 and thereby possibly resulting in an increased noise emission.

FIG. 24 chows a sectional view along the sectional line XXIIb-XXIIb in FIG. 22.

FIG. 24 shows the ribs 366, which taper on both side walls 348 and 350 of the housing 316, narrowing the cross section of the receiving section 322 in the direction of the bottom 367 of the housing part 316. The ribs 366 extend obliquely in the direction of the bottom 367. The ribs 366 can secure the damper mass 326 in the housing 312 if the damper mass 326 is freely movable in the housing 312 after failure of one of the spring elements 328, 330. The ribs 366 may also be designed in a conical shape.

FIG. 25 shows a side view of the device 310.

FIG. 26 shows a sectional view along the sectional line XXV-XXV in FIG. 25.

FIG. 26 shows the ribs 366 on the side walls 348 and 350, the ribs being capable of securing the damper mass 326 in the housing 312 and/or in the housing part 316.

FIG. 27 shows a perspective view of a device 410 according to a fifth embodiment of the invention.

The device 410 is designed to be designed to be round, i.e., circular in contrast with the embodiments described above.

The housing 412 is comprised of two housing parts 414 and 416. The housing 412 in turn has a retaining site 318 which extends around the receiving section 422 for the damper mass (not shown in FIG. 27) in the form of a ring. Reinforcing ribs 424 for the housing 412 are provided between the retaining site 418 and the retaining section 422.

FIG. 28 shows a perspective view of the device 410 without the housing part 416. The device 410 has three spring elements 428, 430 and 468. The spring elements 428, 430 and 468 serve to couple the damper mass 426 to the housing 412. The retaining site 418 extends in a circular arrangement around the receiving section 422. The retaining site 418 receives the fastening elements 430, 432 and 470 of the spring elements 428, 430 and 468. The damper mass 426 is designed in a cylindrical shape. The spring elements 428, 430, 468 are offset by 120° from one another on the circumference of the damper mass 426. The fastening elements 436, 438 and 470 according to this embodiment are again designed with a triangular cross section.

The spring elements 428, 430 and 468 each have a spring section 432, 434 and 472, connecting the fastening elements 432, 434 and 470 to the damper mass 426.

FIG. 29 shows a top view of the device 410 showing its round, i.e., circular shape.

FIG. 30 shows a sectional view along the sectional line XXIX-XXIX in FIG. 29.

The housing 412 is composed of two housing parts 414 and 416. The damper mass 426 is coupled to the housing 412 by the spring elements 428, 430 and 468. To do so, the spring elements, i.e., the spring element 430 in FIG. 30 have fastening elements 434. The housing parts 414 and 416 form a retaining site 418 in the assembled state, designed with a rectangular cross section and extending in a ring shape around the damper mass 426. The retaining site 418 is designed to be complementary to the triangular cross section of the fastening elements 432, 434 and 470. The damper mass 426 is completely embedded in the elastomer used to produce the spring elements 428, 430 and 468.

FIG. 31 shows a side view of the device 410 showing the two housing halves 414, 416 of the housing 412.

FIG. 32 shows a sectional view along the sectional line XXXI-XXXI in FIG. 31.

The spring elements are offset by 120° from one another on the circumference of the cylindrical damper mass 426. Starting from the damper mass 426, the spring elements 428, 430 and 468 extend with their spring sections 432, 434 and 472 in the direction of the retaining site 418. The fastening elements 436, 438 and 470 of the spring elements 428, 430 and 468 are accommodated in the retaining site 418.

FIG. 33 shows a perspective view of a device 510 according to a sixth embodiment of the invention.

The device 510 comprises a retaining device 512, which is designed in the form of a housing. The retaining device 512 is comprised of two housing parts 514 (see FIG. 34) and 516. The retaining device 512 comprises four retaining sites 518, 520, 574 and 576. The retaining sites 518, 520, 574, 576 serve to connect with a spring element; of those shown in FIG. 33, only the spring elements 528 and 578 can be discerned. The spring elements 528 and 578 each have a spring section 532 and 580, which develops into a fastening section 536 and 582. The spring sections 532 and 580 also serve to connect with the damper mass 526. The fastening sections and/or fastening elements 536 and 582 are accommodated in the retaining sites 518 and 574, coupling the spring elements 528, 578 to the retaining sites 518, 574 of the housing halves 516. The spring elements 528 and 578 are put under tensile load and/or shearing according to this embodiment.

FIG. 34 shows a top view of the device 510.

The retaining device 512 has a receiving section 522 for the damper mass 526 in which the damper mass can oscillate in vertical and horizontal directions, i.e., in the X and Y directions for damping vibrations and oscillations.

FIG. 34 shows a top view of the device 510, illustrating the housing parts 514 and 516 of the retaining device 512. The housing parts 514 and 516 have the retaining sites 518 and 574.

FIG. 35 shows a sectional view along the sectional line XXXV-XXXV in FIG. 34.

The retaining device 512 has the receiving section 522 in which the damper mass 526 and also in some sections the spring elements 578 and 584 are accommodated.

The spring elements 578 and 584 each have a spring section 580, 586 and a fastening element 582, 588 which are accommodated in the retaining sites 574 and 576. The damper mass 526 is surrounded completely by the material used for the spring elements 578 and 584, for example, an elastomer.

FIG. 36 shows a sectional view along the sectional line XXXVI-XXXVI in FIG. 34.

FIG. 36 shows the four spring elements 528, 530, 578 and 584. The spring elements 528, 530, 578 and 584 each have a spring section 532, 534, 580, 586 and a fastening section 536, 538, 582 and 588, which are accommodated in the retaining sites 518, 520, 574 and 576 of the housing part 514.

The spring elements 528, 530, 578 and 584 each extend between the walls 544 and 546 and the surfaces 590 and 592 of the damper mass 526 that are opposite these walls 544, 546. The walls 544 and 546 extend essentially parallel to the surfaces 590, 592 of the damper mass 526 in the resting state of the device 510. The walls 544, 546 and the surfaces 590, 592 run essentially in the X direction in the resting state of the device 510 whereas the spring elements 528, 530, 578 and 584 extend in the Z direction.

FIG. 37 shows a perspective view of a device 610 according to a seventh embodiment.

The device 610 comprises a retaining device 612, only the housing part 616 of which is discernible in FIG. 37. The damper mass 626 is connected by the spring elements 628 and 630 to the retaining sites 618, 620 of the housing part 616. To do so, the fastening elements 636 and 638 of the spring elements 626 and 630 are accommodated in the retaining sites 618, 620. Between the damper mass 626 and the fastening elements 636 and 638, the spring sections 632 and 634 of the spring elements 628, 630 extend.

FIG. 38 shows a front view of the device 610.

The retaining device 612 comprises two housing parts 614 which have the retaining sites 618, 620.

FIG. 39 shows a sectional view along the sectional line XXXIX-XXXIX in FIG. 38.

The spring elements 630 and 678 are accommodated in the retaining sites 620 and 674 of the housing parts 614 and 616. The retaining sites 614 and 616 form a receiving section 622 between them for the damper mass 626. The spring elements 630, 678 connect the damper mass 626 to the housing parts 614, 616. The spring elements 630, 678 are subjected to a tensile load during the operation of the device 610.

FIG. 40 shows a sectional view along the sectional line XL-XL in FIG. 38.

FIG. 40 shows the four spring elements 628, 630, 678 and 684, which connect the housing parts 614, 616 to the damper mass 626.

The spring elements 628, 630, 678 and 684 are accommodated with their fastening sections 636, 638, 682 and 688 in the retaining sites 618, 620, 674 and 676.

The spring elements 628, 630, 678 and 684 according to this embodiment extend in the Y direction. The areas 690, 692 of the damper mass are opposite the surfaces 648, 650 of the housing parts 614, 616. The walls 648 and the surfaces 690, 692 are run in the X direction.

FIG. 41 shows a perspective view of the device 710 according to an eighth embodiment of the invention.

The device 710 comprises a retaining device 712 of which only the housing half 716 is shown.

The damper mass 726 is accommodated in the retaining device 712. The spring elements 728 and 730 extend between the retaining device 712 and/or the housing part 716 and the damper mass 726. The device 710 also comprises a type of hinge S by means of which the damper mass 726 is connected to the retaining device 712. The hinges S are formed by a bearing journal 794 and a bearing section 796 on the damper mass 726. The bearing journal 794 is accommodated in an opening O in the bearing section 796 and is supported on a bearing 798 of the housing part 716.

FIG. 42 shows a front view of the device 710, showing the housing parts 714, 716 of the retaining device 712 with their retaining sites 718, 720.

FIG. 43 shows a sectional view along the sectional line XLIII-XLIII in FIG. 42.

FIG. 43 shows the hinge S which is formed by the bearing journal 794 and a bearing section 796 of the damper mass 726. The bearing journal 794 is accommodated in an opening O of the bearing section 796. The housing parts 714, 716 in turn form a receiving section 722 for the damper mass 726. The damper mass 726 is mounted on the retaining device 712 and/or the housing parts 714, 716 by means of the hinge S in a pivoting movable mount.

FIG. 44 shows a sectional view along the sectional line XLIV-XLIV in FIG. 42.

The spring elements 728, 730 connect the damper mass 726 to the housing part 714 and extend in the X direction. The damper mass 726 is also mounted in a pivotably movable manner on the housing parts 714, 716 by means of the hinges S. The housing part 714 therefore has a bearing site 798, which supports the bearing journal 794 on the housing part 714. The bearing 794 is accommodated in an opening O in a bearing section 796 of the damper mass 726. With a movement of the damper mass 726, the damper mass 726 can pivot about the bearing journal 794. In doing so, the spring elements 728, 730 are subjected to a tensile load. Vibrations and oscillations can be reduced by the pivoting movement of the damper mass 726.

FIG. 45 shows a perspective view of a device 810 according to a ninth embodiment of the invention.

The damper mass 826 has hinges S, which mount the damper mass 826 on the retaining device 812. The bearing sections 896 also have the spring elements 828 and 830 according to this embodiment extending between the bearing sections 896 of the damper mass 726 and the retaining device 812. The retaining device 812 according to this embodiment is comprised of three parts, of which only the parts 816 and 899 are shown in FIG. 45.

FIG. 46 shows a front view of the device 810 in which the three housing parts 814, 816 and 899 are shown. The housing parts 814, 816 and 899 together form the retaining sites 818, 820, 874 and 876.

FIG. 47 shows a sectional view along the sectional line XLVII-XLVII in FIG. 46.

FIG. 47 shows the three housing parts 814, 816 and 899 which form the retaining sites 874, 820. The damper mass 826 is supported via the bearing journal 894, so that it can pivot on the housing parts 814, 816, 899. The spring elements 830 and 878 which extend in the direction of the housing parts 814, 816 and 899 starting from the bearing section 896 are provided on the bearing sections 896 of the damper mass 826. The spring elements 830 and 878 are alternately subjected to tensile loading and compressive loading due to the pivoting movement of the damper mass 826.

FIG. 48 shows a sectional view along the sectional line XLVIII-XLVIII in FIG. 46.

The damper mass 826 according to this embodiment has the hinges S by means of which the damper mass 826 is mounted on the retaining device 812 so that it is pivotably movable. The retaining site 814, 816 (not shown in FIG. 48) and 899 form the bearing sites 898 for the bearing journals 894.

The damper mass 826 is designed in the form of a U as in the embodiment described above.

FIG. 49 shows a perspective view of a device 910 according to a tenth embodiment of the invention.

The device 910 has a damping device DE which is formed according to this embodiment by two damper masses 926 connected to one another by means of spring elements 928, 930. The damper masses 926 are accommodated in the receiving section 922 in the retaining device 912 and/or in the housing part 914 of the retaining 912.

The damper masses 926 are mounted on the retaining device 912 and/or the housing part 914 in a pivotably movably manner by means of the hinges S.

In this embodiment, the hinges S are also formed by the bearing journal 944, which is accommodated in a bearing section 996 of the damper masses 926 and is supported on a bearing site 998 of the housing part 914.

FIG. 50 shows a front view of the device 910, illustrating the housing halves 914 and 916 of the retaining device 912.

FIG. 51 shows a sectional view along the sectional line LI-LI in FIG. 50.

FIG. 51 shows the two damper masses 926, which are connected by a spring element 930. Both of the damper masses 926 are mounted on the retaining device 912 and/or the housing halves 914 and 916 by means of the hinges S.

When the damper masses 926 are pivoted about the bearing journal 994 because of vibrations or oscillations, the damper masses 926 execute a movement relative to one another, and the spring 930 is subjected to a tensile load. Due to the movements of the damper masses 926 and the associated load on the spring element 930, vibrations and oscillations can be damped with the device 910.

FIG. 52 shows a sectional view along the sectional line LII-LII in FIG. 50.

FIG. 52 shows the two damper masses 926 which are connected to one another via the spring elements 928 and 930. The damper masses 926 are mounted on the housing part 914 by means of the hinges S, so that they are pivotabty movable on the housing part 914. To accommodate the bearing journals 994, the housing part 914 has bearing sites 998. The bearing journals 994 have been accommodated in an opening O in the bearing sections 996 of the damper masses 926. With pivoting movements of the two damper masses 926, the spring elements 928 and 930 are subjected to a tensile load.

According to an eleventh embodiment of the invention, FIG. 53 shows a perspective view of a device 1010, in particular for damping flexural vibrations and/or torsional vibrations, for example, on shafts.

The device 1010 comprises a retaining device 1012. According to this embodiment, the retaining device 1012 is designed to be ring-shaped and has an inside circumferential wall 1100 and an outside circumferential wall 1102. The retaining device 1012, i.e., the housing 1012, is comprised of two components 1014 and 1016. Component 1014 here forms a closure element or a cover for sealing the component 1016.

FIG. 54 shows a perspective view of the device 1010 in which the component 1014, i.e., the closure element has been accommodated.

The closure element 1014 is designed in the form of a disk. The second component 1016 is designed with a U-shaped cross section, wherein the inside circumferential wall 1100 and the outside circumferential wall 1102 form two legs of the U shape which are connected to one another by means of a transverse leg (not shown in FIG. 54). Between the inside circumferential wall 1100 and the outside circumferential wall 1102, the damping device DE is accommodated. The damping device DE is comprised of an annular damper mass 1026 which is connected to the component 1016 by means of a spring element 1028. The spring element 1028 is designed in the form of a ring and extends between an inside circumferential area 1004 of the damper mass 1026 and a radially exterior surface 1106 of the inside circumferential wall 1100 of the retaining device 1012 and/or of the component 1016. The radial outer surface 1006 of the inside circumferential wall 1100 of the retaining device 1012 and/or of the component 1016. The outer radial surface 1106 of the inside circumferential wall 1100 forms a retaining site 1018 for the spring element 1028 and/or for the damping device DE.

FIG. 55 show a top view of the device 1010 in which the component 1016 can be recognized in particular.

In the top view according to FIG. 55, the annular shape of the device 1010 can be seen with the inside circumferential wall 1100 and the outside circumferential wall 1102.

FIG. 56 shows a sectional view along the sectional line LVI-LVI in FIG. 55.

The component 1016 is designed with a U-shaped cross section and can be sealed by the component 1014 to form a sealed receptacle section 1022 with the component 1014. The component 1014 is designed in the form of a disk.

The component 1016, which is designed with a U-shaped cross section, also has a transverse leg 1108 connecting the two legs 1100 and 1102, in addition to having the two U legs formed by the inside circumferential wall 110 and the outside circumferential wall 1102.

The damping device DE is accommodated in the receiving section 1022. The receiving section 1022 is formed by the two components 1014 and 1016. The damper mass 1026 is designed in a ring shape and has a rectangular cross section.

The spring element 1028 extends between the inside circumferential surface 1104 of the damper mass 1026 and the radial outer surface 1106 of the inside circumferential wall 1000. The spring element 1028 is designed in a ring shape. The spring element 1028 may be in contact with the radial outer surface 1106 of the inside circumferential wall 1100. The radially outer surface 1106 of the inside circumferential wall 1100 forms a retaining site 1018 for the spring element 1028 and establishes a connection between the retaining device 1012 and the damping device DE.

Between the outside circumferential surface 1110 and the side surfaces 1112 and 1114 of the damper mass 1026 and the components 1014 and 1016, a gap s is formed. The gap s ensures that the damper mass 1026 can oscillate for oscillation damping in the receiving section 1022 of the retaining device 1012. For oscillation damping the damper mass 1026 can be deflected in the radial direction. It is also possible for the damper mass 1026 to be deflected in the axial direction of the axis M for vibration damping. The respective gap s defines a maximum deflection of the damper mass 1026 relative to the retaining device 1012, i.e., it limits the deflection of the damper mass 1026 relative to the retaining device 1012.

The spring element 1028 is connected to the damper mass 1026 before the damping device DE formed by the damper mass 1026 and the spring element 1028 is connected to the retaining device 1012. The spring element 1028 is connected to the inside circumferential surface 1104 of the damper mass 1026. Following that, the damping device DE, i.e., the damper mass 1026 on the spring element 1028 is pressed into the component 1016 and/or the spring element 1028 is pressed onto the radial outer surface 1106 of the inside circumferential wall 1100 of the component 1016. In this way, the spring element 1028 is provided with a predetermined bias. The spring element 1028 holds the damper mass 1026 in a predetermined position on the retaining device 1012, i.e., on the component 1016 in the resting state of the device 1010. Following the mounting of the damping device DE, the housing, i.e., the retaining device 1012, is sealed with the component 1014. For connecting the two components 1014 and 1016, for example, catch noses or the like can be provided on the components 1014 and 1016.

FIG. 57 shows a top view of a device 2010 according to a twelfth embodiment of the invention.

The device 2010 has a retaining device, i.e., a housing 2012, of which only the housing half 2014 is shown in FIG. 57. Retaining sites 2018 and 2020 for the spring elements 2028 and 2030 are formed on the housing half 2014. Of the spring elements 2028 and 2030, FIG. 57 shows only the fastening sections 2036 and 2038 which are designed in the form of a thickened area.

The device 2010 according to this embodiment is designed in the shape of a rod.

FIG. 58 shows a sectional view along the sectional line LVIII-LVIII in FIG. 57.

The device 2010 has a retaining device 2012 and a damper mass 2026. The damper mass 2026 is connected to the retaining device 2012, i.e., the housing halves 2014 and 2016 by the spring element 2030. Therefore, a retaining site 2020 is formed on the housing half 2014. A retaining site 2076 is formed on the housing half 2016. The spring element 2030 extends between the retaining sites 2020 and 2076 through the damper mass 2026. The spring element 2030 is connected to the retaining sites 2020 and 2076 of the housing halves 2014, 2016 by its fastening sections 2036 and 2088. The fastening sections 2036 and 2088 are designed in the form of thickened areas, in particular in the form of cambered thickened areas and are accommodated in the retaining sites 2020 and 2076, which are offset toward the inside in the direction of the damper mass 2026. The spring 2030 comprises a spring web 2116 and is connected to the damper mass 2026 by the spring web 2116. The spring web 2116 is connected to a bushing 2118. The bushing 2118 is accommodated in an opening 2120 in the damper mass 2026. The spring element 2030 extends between its fastening sections 2038 and 2088 through the opening 2120 in the damper mass 2026. The inside circumferential surface of the bushing 2118 is coated with the material of the spring element 2030. The spring element 2030 has stop buffers AP which are provided on the end faces of the bushing 2118. The stop buffers AP can reduce the impact of the damper mass 2026 on the retaining device 2012.

The damper mass 2026 has side faces 2122 and 2124 which extend parallel to the spring sections 2034 and 2086 of the spring element 2030, i.e., the side surfaces 2122 and 2124 extend in the Y direction. Between the side surfaces 2122 of the damper mass 2026 and the surface 2126 of the retaining device 2012 opposite this side surface, a predetermined gap s is formed. In contrast with that, the side surface 2124 is in contact with the surface 2128 of the retaining device 2012. Therefore, the receiving sections 2022 formed by the housing halves 2014 and 2016 is subdivided into two chambers 2120 and 2132. It can be seen in FIG. 58 that the dimension of the gap s changes in the X direction due to the shape of the surface 2126. The damper mass 2026 oscillates in the Y direction under the load of the spring element 2030. In the Y direction, i.e., in the direction of oscillation of the damper mass 2026, the gap s is reduced when the damper mass 2026 is deflected in the direction of the housing surfaces 2044 and 2046. The surface 2126 has a kink 2134, which lies essentially in the area of the connection point of the housing halves 2014 and 2016.

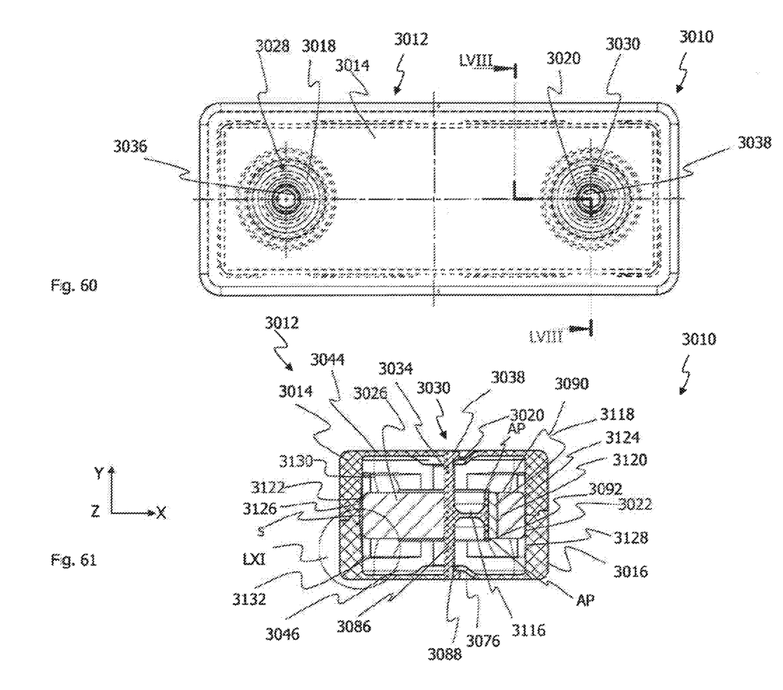

FIG. 59 shows an enlarged view of the detail LIX in FIG. 58.

FIG. 59 shows the damper mass 2026 and the housing halves 2014 and 2016 in sections.

The gap s is inserted between the side face 2122 of the damper mass 2026 and the surface 2126 of the housing halves 2014 and 2016. The surface 2126 on the housing halves 2014 and 2016 has a kink 2134, which is situated on the connecting site between the housing halves 2014 and 2016. In this location 2134, the gap s is largest in the X direction. The gap s becomes smaller in the direction of the surface 2044, i.e., continuously in the Y direction. With a deflection of the damper mass 2026 in the Y direction, the gap s between the surface 2122 of the damper mass 2026 and the surface 2126 of the housing halves 2014 and 2016 becomes smaller continuously with an increase in the deflection. Therefore, only a very small amount of air in the chamber 2132 can flow between the damper mass 2026 and the surface 2126. The air cushion formed in the chamber 2132 brakes the damper mass 2026, so that a variable damping, in particular progressive damping of the damper mass 2026 is achieved and the damper mass 2026 can be prevented from striking the damper mass 2026 against the housing halves 2014, 2016. If adequate damping cannot be provided by means of the air cushions, the impact of the damper mass 2026 on the retaining device 2012 can be reduced by means of one of the stop buffers AP.

The size of the air gap s between the surface 2122 of the damper mass 2026 and the surface 2126 of the housing parts 2014, 2016 is reduced, the further the damper mass 2026 is deflected in the Y direction, i.e., the greater the amplitude of the damper mass 2026. Starting from the surface 2044, the surface 2126 runs continuously up to the kink 2134, i.e., the gap s becomes larger continuously.

The thirteenth embodiment of the invention illustrated in FIGS. 60 to 62 corresponds largely to the twelfth embodiment described with reference to FIGS. 57 to 59.

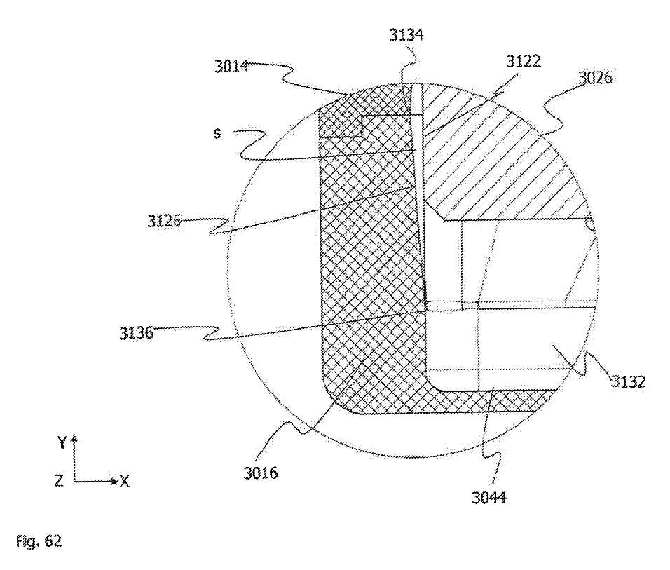

The only important difference between the two embodiments is that additional kink points are provided on the surface 2126. The following embodiments relate to the housing part 2016, a large detail of which is illustrated in FIG. 62, but they also apply similarly to the housing part 2016.

In a first section the surface 2126 runs parallel to the Y axis and beyond the kink 2136 the surface 2126 runs at an angle to the Y axis in a second section, so that the gap s between the damper mass 2026 and the surface 2126 becomes larger up to the kink 2134. The kink 2134 is situated between the two housing halves 2014, 2016 at the connection point. Starting from the first kink 2134 the gap s becomes smaller again up to the third kink 2138 because of the angled course of the surface 2126 to the Y axis.

Due to the contour, i.e., the shape of the surface 2126, the amplitude of the damper mass 2026 can be adjusted. In a comparison of the twelfth embodiment (FIGS. 57 to 59) and the thirteenth embodiment (FIGS. 60 to 62), it can be seen that in the thirteenth embodiment its extent in the X direction can be reduced more rapidly than is the case with the twelfth embodiment, so that the maximum allows amplitude of the damper mass 2026 is smaller in the thirteenth embodiment.

1-28. (canceled)

29. A device for damping vibrations, having at least one damping device and at least one retaining device for the damping device, wherein the at least one damping device is connected to the at least one retaining device and wherein the at least one damping device comprises at least one damper mass and at least one spring element, wherein the at least one spring element is designed and preloaded so that the at least one spring element holds the at least one damper mass in a predetermined position on the at least one retaining device in the resting state of the device.

30. The device according to claim 29, wherein the at least one spring element has a predetermined preload.

31. The device according to claim 29, wherein at least one damping device is accommodated in the at least one retaining device.

32. The device according to claim 29, wherein the at least one retaining device is formed from at least two components which can be connected so as to receive the at least one damping device.

33. The device according to claim 29, wherein the at least one retaining device has at least one retaining site which is used for coupling to the at least one spring element.

34. The device according to claim 29, wherein the at least one spring element is designed with at least one fastening element.

35. The device according to claim 34, wherein the at least one fastening element can be accommodated in the at least one retaining site of the at least one retaining device.

36. The device according to claim 35, wherein the at least one fastening element of the at least one spring element is designed to be complementary to the at least one retaining site of the at least one retaining device.

37. The device according to claim 29, wherein the at least one damper mass is designed in multiple parts.

38. The device according to claim 29, wherein the damper mass is designed to be cylindrical, rod-shaped or ring-shaped.

39. The device according to claim 29, wherein the at least one spring element has at least one reinforcement, in particular at textile reinforcement.

40. The device according to claim 29, wherein the retaining device has ribs which serve to secure the damper mass in the event of failure of the at least one spring element.

41. The device according to claim 29, wherein the at least one damping device is connected to the at least one rotating device so that it is pivotably movable.

42. The device according to claim 29, wherein the at least one rotating device has a fluid damping the movements of the at least one damper mass.

43. The device according to claim 29, wherein the at least one retaining device has at least one throttle element which throttles a fluid flow occurring due to the movement of the at least one damper mass.

44. The device according to claim 29, wherein the at least one retaining device is designed in a ring shape.

45. The device according to claim 44, wherein the at least one annular retaining device has at least one inside circumferential wall and at least one outside circumferential wall.

46. The device according to claim 45, wherein the at least one damping device is connected to the at least one inside circumferential wall.

47. The device according to claim 46, wherein the at least one spring element of the at least one damping device extends between the at least one inside circumferential wall and the at least one damper mass.

48. The device according to claim 47, wherein the at least one spring element is fixed connected to the at least one damper mass before being mounted on the at least one retaining device.

49. The device according to claim 29, wherein the at least one retaining device is designed so that at least one predetermined gap is established between the at least one damper mass and the at least one retaining device.

50. The device according to claim 49, wherein the at least one retaining device is designed so that the at least one predetermined gap changes with the deflection relative to the at least one retaining device in deflection of the at least one damper mass.

51. The device according to claim 49, wherein the at least one predetermined gap is largest in at least one location in the resting state of the device.

52. The device according to claim 50, wherein the at least one retaining device is designed so that the at least one predetermined gap decreases with an increase in the vibration amplitude of the at least one damper mass.

53. The device according to claim 33, wherein the at least one spring element extends between at least two retaining sites.

54. The device according to claim 53, wherein the at least one spring element extends through an opening in the at least one damper mass and is connected to the at least one damper mass.

55. The device according to claim 54, wherein the at least one spring element is connected to the at least one damper mass by means of at least one spring web, wherein the at least one spring web is in the at least one opening in a resting state of the device.

56. The device according to claim 49, wherein the at least one spring element has at least one section which serves as a stop buffer.
